(19) United States
(12) Patent Application Publication
(10) Pub. No.: US 2026/0003497 A1
(43) Pub. Date: Jan. 1, 2026

(54) DISPLAY CONTROL METHOD AND ELECTRONIC APPARATUS

(71) Applicant: Lenovo (Beijing) Limited, Beijing (CN)

(72) Inventor: Ke WANG, Beijing (CN)

(21) Appl. No.: 19/222,733

(22) Filed: May 29, 2025

(30) Foreign Application Priority Data
Jun. 29, 2024 (CN) 202410870501.9

(51) Int. Cl. G06F 3/04886; G06F 1/16; G06F 3/04883

(52) U.S. Cl. CPC G06F 3/04886; G06F 1/1673; G06F 3/04883; G06F 2203/04803

(57) ABSTRACT

A display control method includes determining a positional relationship between a display screen of an electronic apparatus and an input device, and controlling displaying of a target display area of the display screen at least based on the positional relationship and attribute information of the input device. The target display area is an area not covered by the input device.

### CROSS-REFERENCE TO RELATED APPLICATION

This application claims priority to Chinese Patent Application No. 202410870501.9, filed on Jun. 29, 2024, the entire content of which is incorporated herein by reference.

### TECHNICAL FIELD

The present disclosure generally relates to the field of display control technologies and, more particularly, to a display control method and an electronic apparatus.

### BACKGROUND

For an electronic apparatus with dual screens or a flexible screen, when connecting a keyboard, users need to manually set the display screen, which has a low degree of automation and is cumbersome, affecting user efficiency.

### SUMMARY

In accordance with the disclosure, there is provided a display control method including determining a positional relationship between a display screen of an electronic apparatus and an input device, and controlling displaying of a target display area of the display screen at least based on the positional relationship and attribute information of the input device. The target display area is an area not covered by the input device.

Also in accordance with the disclosure, there is provided an electronic apparatus including a main body, a display screen arranged at the main body, an input device configured to move relative to the display screen, a detector configured to determine a positional relationship between the display screen and the input device, and a processor configured to control displaying of a target display area of the display screen at least based on the positional relationship and attribute information of the input device. The target display area is an area not covered by the input device.

### BRIEF DESCRIPTION OF THE DRAWINGS

To more clearly illustrate the technical solutions of the embodiments of the present disclosure, the drawings for use in the description of the embodiments will be briefly introduced below. The drawings described below are some embodiments of the present disclosure. For those of ordinary skill in the art, other drawings can be obtained according to these drawings without any creative work.

FIG. 1 is a flow chart of a display control method consistent with embodiments of the present disclosure

FIG. 2 is a schematic diagram showing a target display area consistent with embodiments of the present disclosure.

FIG. 3 is another schematic diagram showing a target display area consistent with embodiments of the present disclosure.

FIG. 4 is another schematic diagram showing a target display area consistent with embodiments of the present disclosure.

FIG. 5 is a schematic diagram showing a keyboard placed on a first display screen and a second display screen at the same time consistent with embodiments of the present disclosure.

FIG. 6 is another schematic diagram showing a keyboard placed on a first display screen and a second display screen at the same time consistent with embodiments of the present disclosure.

FIG. 7 is another schematic diagram showing a keyboard placed on a first display screen and a second display screen at the same time consistent with embodiments of the present disclosure.

FIG. 8 is another schematic diagram showing a keyboard placed on a first display screen and a second display screen at the same time consistent with embodiments of the present disclosure.

FIG. 9 is a schematic diagram showing a keyboard placed on a foldable screen at the same time consistent with embodiments of the present disclosure.

FIG. 10 is a schematic diagram of an electronic apparatus consistent with embodiments of the present disclosure.

### DETAILED DESCRIPTION OF THE EMBODIMENTS

Various schemes and features of the present disclosure are described herein with reference to the accompanying drawings.

It should be understood that various modifications may be made to the embodiments of the present disclosure. Therefore, the description should not be regarded as limiting, but only as examples of the embodiments. Based on the embodiments in the present disclosure, all other embodiments obtained by those skilled in the art without creative work are within the scope of the present disclosure.

The accompanying drawings, which are included in and constitute a part of the specification, illustrate embodiments of the present disclosure and are used together with the general description of the present disclosure given above and the detailed description of the embodiments given below to explain the principles of the present disclosure.

These and other features of the present disclosure will become apparent from the following description of preferred forms of embodiments given as non-limiting examples with reference to the accompanying drawings.

It should also be understood that although the present application has been described with reference to some specific examples, those skilled in the art will be able to realize many other equivalent forms of the present disclosure with certainty, which have the characteristics described in the claims and are therefore all within the scope of protection defined thereby.

Specific embodiments of the present disclosure are described hereinafter with reference to the accompanying drawings. However, it should be understood that the embodiments applied for are merely examples of the present disclosure, which can be implemented in many ways. Well-known and/or repeated functions and structures are not described in detail to avoid unnecessary or redundant details that make the present application unclear. Therefore, the specific structural and functional details applied for herein are not intended to be limiting, but are merely used as the basis and representative basis for the claims to teach those skilled in the art to use the present disclosure in a variety of ways with substantially any suitable detailed structure.

This specification may use the phrases “in one embodiment,” “in another embodiment,” or “in other embodiments,” which may refer to one or more of the same or different embodiments according to the present disclosure.

To meet the needs of users, more and more electronic apparatuses are designed as dual screens or foldable screens, and the display control method provided in the present disclosure may be applied to the above electronic apparatuses. To facilitate the understanding of the present disclosure, a display control method provided in the present disclosure is first described in detail.

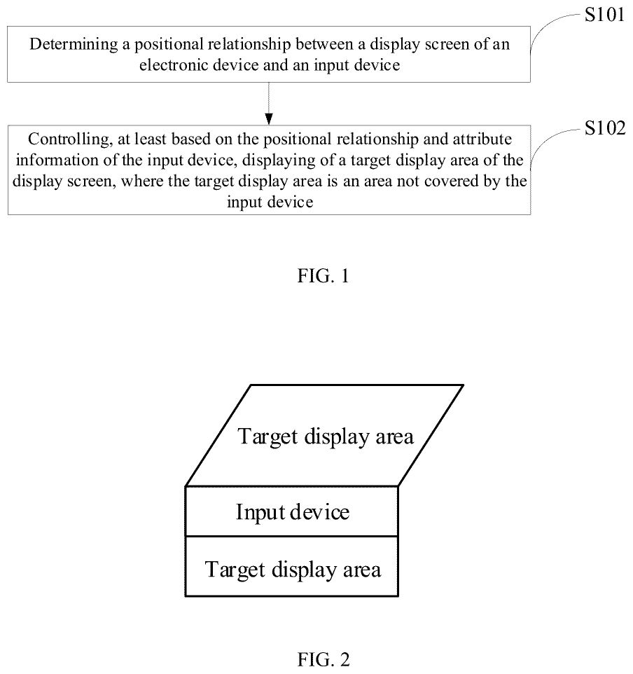

The present disclosure provides a display control method. In one embodiment, as shown in FIG. 1, which is a flow chart of the display control method according to the present disclosure, the display control method includes S101 and S102.

At S101, a positional relationship between a display screen of an electronic apparatus and an input device is determined.

In one embodiment of the present application, the electronic apparatus may be a mobile phone, a tablet computer, a laptop computer, a dual-screen laptop computer, a display, or a large-screen desktop device, etc. The display screen of the electronic apparatus may be a dual-screen notebook, a foldable screen notebook, a display screen of a large-screen device, a display screen of a display, etc.

In one embodiment, the electronic apparatus may usually also be equipped with the input device for use with the electronic apparatus, such as a keyboard, an integrated keyboard and touchpad, a specific writing tablet, an input pen, a gesture recognition device, etc. In the present embodiment, a detachable keyboard and touchpad design is provided, that is, only the keyboard part or the touchpad part may be selected to cooperate with the electronic apparatus to realize the relevant functions.

In the display control method provided by the present embodiment, for the electronic apparatus, the positional relationship between its display screen and the input device may be determined. The positional relationship may be mainly reflected in whether the input device covers a portion of a display area of the display screen or whether there is a physical connection relationship with a connection interface of a body where the display screen is located. For example, when the input device is an integrated keyboard, the integrated keyboard may be physically connected to the display screen through a connecting line or a connection interface. When the input device is an external keyboard and the external keyboard is placed on an area of the display screen, the positional relationship between the display screen and the input device may be a covering relationship. When the input device is an external keyboard, an external touch panel, or an external writing tablet, the above-mentioned input device may be electrically connected to the electronic apparatus through connecting pins, or it may be placed on the display area of the display screen and wirelessly connected to the display screen or the host system of the electronic apparatus. Of course, the positional relationship between the display screen and the input device may also include other relationships, which are not exemplified one by one in the embodiments of the present disclosure.

In some other embodiments, the electronic apparatus may include one or more input devices. For example, an electronic apparatus with a detachable keyboard and a touch panel is provided with two input devices.

S102, displaying of a target display area of the display screen is controlled at least based on the positional relationship and attribute information of the input device, where the target display area is an area not covered by the input device.

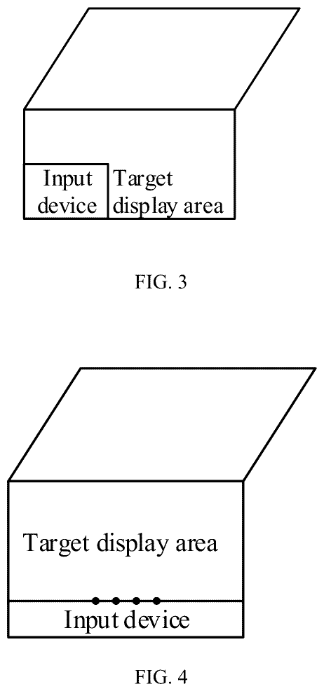

After determining the positional relationship between the display screen and the input device, whether the positional relationship between the display screen and the input device is a covering relationship may be determined. When the positional relationship between the display screen and the input device is the covering relationship, at least a portion of the area on the display screen that is not covered by the input device may be determined as the target display area, where the target display area may be located in the area not covered by the input device and adjacent to the input device, such as the right side area or the upper and lower side areas of the input device as shown in FIG. 2 and FIG. 3, or may be the margin area formed by the edge of the display screen that the input device does not cover, or a user-specified area, etc.

After determining the target display area, the displaying of the target display area of the display screen may be controlled at least based on the positional relationship and the attribute information of the input device. For example, at least the display content (what controls and/or interfaces, windows, etc. may be displayed), display area (display position, etc.), display layout (positional relationship between controls or windows, etc.), or display parameters (brightness, resolution, transparency, color theme, skin, etc.) of the target display area may be controlled. The attribute information of the input device may at least include information such as the type of the input device, device identification, device configuration, or appearance.

Optionally, in one embodiment, when controlling the displaying of the target display area, user portrait information, current display content of the electronic apparatus, usage scenario of the electronic apparatus, power information of the electronic apparatus, or the device form of the electronic apparatus may also be obtained, and then the displaying of the target display area may be controlled based on one or more of the positional relationship, the attribute information of the input device, the user portrait information, the current display content of the electronic apparatus, the usage scenario of the electronic apparatus, the power information of the electronic apparatus, or the device form of the electronic apparatus.

Further, in another embodiment, two input devices may be provided on the electronic apparatus, and the target display area may be controlled to be displayed differently based on the relative positional relationship between the two input devices.

In the display control method provided by the embodiments of the present disclosure, the positional relationship between the display screen of the electronic apparatus and the input device may be determined in real time and automatically, and when the positional relationship between the display screen and the input device is the covering relationship, the displaying of the target display area may be controlled at least based on the positional relationship between the display screen and the input device or the attribute information of the input device, without the need for manual setting by the user, which greatly improves the user's use efficiency.

In some embodiments, the positional relationship between the display screen of the electronic apparatus and the input device may be determined by at least one of the following methods.

In one embodiment, the positional relationship may be determined by sensing data obtained by a target sensing assembly, and the target sensing assembly may include at least one sensor set in the display screen, the body where the display screen is located, or the input device. Optionally, the target sensing assembly may include at least one of a pressure sensor, a magnetic sensor, a touch sensor, a Hall sensor, a capacitive sensor, a resistance sensor, or an image sensor. And, the corresponding sensing data may include collected pressure data, capacitance data, resistance data, magnetic flux, magnetic force, image, etc.

For example, when the target sensing assembly is an image sensor and the image sensor is set on the display screen, such as the B-side display screen of a laptop computer, the image sensor may collect the image of the C-side screen, and then perform object recognition and spatial calculation on the image to obtain the positional relationship between the input device and the display screen.

In another example, a capacitive touch sensor and/or a pressure sensor may be set on the electronic apparatus, which may collect touch capacitance data and/or pressure data of the display screen, and calculate the position, an area of the region, etc. of the input device placed on the touch display screen based on the touch capacitance data and/or pressure data.

In another embodiment, the positional relationship may be determined by an interface state of a connection interface set on the body where the display screen is located. Usually, the device body of the electronic apparatus may be provided with a plurality of different input/output interfaces (IO), that is, connection interfaces. Different connection interfaces may be used to connect different input devices, such as a pogo pin, a magnetic interface, a USB/type-c, a thunderbolt interface, etc. Also, the plurality of connection interfaces may include a wireless communication interface. The interface status of the connection interface may be monitored in real time, such as whether a handshake signal is received, whether it is switched from a high level to a low level, etc., to determine whether there is an input device connected to the electronic apparatus based on the interface status. When there is an input device connected to the electronic apparatus, the connection direction of the input device relative to the electronic apparatus may be determined based on the position of the connection interface in the electronic apparatus, and then the positional relationship between the input device and the display screen may be determined.

For example, a pogo pin may be set at the lower edge between the C and D surfaces of the laptop computer, and a Bluetooth keyboard or touchpad may be connected through the pogo pin. After the pogo pin is connected, it may be determined based on the access signal that a Bluetooth keyboard or touchpad is connected, and then it may be determined that the Bluetooth keyboard or touchpad is set in the lower area of the display screen or in the lower edge area of the electronic apparatus. Also, a magnetic interface may be set on the right edge to place the stylus, and when the interface is plugged in, it may be determined that the stylus is on the right edge of the display screen, etc.

In another embodiment, the positional relationship may be determined based on a first input operation on the display screen. The first input operation may be a pre-set input operation, which may be used to send an instruction to select the input device placement area, such that the electronic apparatus responds to the instruction and sets the area corresponding to the first input operation as the placement area corresponding to the input device. The placement area may be used to place a physical keyboard or display a virtual keyboard or respond to touch operations, etc.

For example, the first input operation may be a circle selection operation performed on the display screen, and the user may circle an area for placing the input device on the touch display screen. Based on the circle selection operation, the positional relationship between the input device and the display screen may be determined. The positional relationship may be a covering relationship, that is, the coverage area of the input device on the display screen may be determined.

In another embodiment, the positional relationship may be determined based on a second input operation on the electronic apparatus. The second input operation may be a voice operation, a gesture operation, etc. After obtaining the second input operation, the operation data may be parsed to determine the placement position of the input device, thereby determining the positional relationship with the display screen. For example, after a gesture operation directed to a touch screen is captured by a camera, the area encircled by the gesture operation may be determined, and the area may be the area determined for placing the input device. Therefore, the position of the encircled area on the screen may be determined by the gesture operation, thereby determining the covered area of the input device such as a keyboard on the screen.

In another embodiment, the positional relationship may be obtained through feedback information from an associated device, and the associated device may be a device that establishes a first communication connection with the electronic apparatus. For example, the associated device may be an external laptop, a desktop, a mobile phone, a watch, etc., or an external input device such as a camera. Further, the feedback information from the associated device may be information representing the placement position of the input device on the screen, and then the positional relationship between the display screen and the input device may be obtained based on the feedback information.

The positional relationship between the display screen and the input device of the electronic apparatus may be determined by one or more of the above five methods.

Further, when controlling the displaying of the target display area of the display screen based at least on the positional relationship and the attribute information of the input device, the attribute information of the input device may be obtained first. The attribute information of the input device may be obtained through sensing data, image data, interface data, input data, or feedback data of an associated device. Afterward, the target display area may be determined based on the positional relationship. After the target display area is determined, the display content and/or display parameters of the target display area may be controlled based only on the attribute information. The target display area may also be determined in combination with the configuration information and/or display state of the display screen to ensure the rationality of the target display area and a better display effect. Different positional relationships and attribute information correspond to different display contents, different display positions, different display parameters, or different display layouts.

Also, when the displaying of the target display area of the display screen is controlled based on at least the positional relationship and the attribute information of the input device, the attribute information such as the type or identification of the input device may be determined based on the image data or interface data obtained, and the target display area may be determined based on the positional relationship and attribute information, and at least one of the display content, display parameters, or display layout of the target display area may be controlled after the target display area on the display screen may be determined.

The method of obtaining the attribute information of the input device may include at least one of the following.

In one embodiment, the image data of the input device obtained by the image sensor may be recognized to obtain the attribute information of the input device. The image sensor may be an image sensor set on the electronic apparatus, or it may be an image sensor connected to the electronic apparatus for communication, etc. The image sensor may collect the image corresponding to the input device, and then obtain the type, device identification, appearance, or other information of the input device through image object recognition, that is, obtain the attribute information of the input device.

In another embodiment, the sensing data obtained by the target sensing assembly may be matched in the target database to obtain the attribute information of the input device. The target sensing assembly may include a pressure sensor, an infrared radar, etc. Correspondingly, the sensing data may include the weight, size, size line shape, etc. of the input device. Then, based on the obtained sensing data, the corresponding input device and the type, device identification, configuration information, appearance or other information of the input device may be screened from the target database to obtain the attribute information of the input device. The target database may be a database stored locally in the electronic apparatus, or it may be a cloud database.

In another embodiment, after the input device is connected to a first connection interface of the electronic apparatus, the attribute information of the input device may be read through the first connection interface. The first connection interface may be a Type-C interface, or a connector such as a pogo pin. A handshake signal may be transmitted through the CC pin or the detection pin in the interface to obtain the attribute information of the input device such as a keyboard and/or a touchpad connected to the electronic apparatus.

In another embodiment, the description information for the input device input to the electronic apparatus may be recognized, to obtain the attribute information of the input device. For example, the user may transmit the description information of the input device to the electronic apparatus in the form of voice, gesture, keyboard input, etc. Correspondingly, the description information may be voice data, gesture image data, or string data. The description information may be used to describe the purpose, type, device identification, appearance, etc. of the input device, and the attribute information of the input device may be obtained based on the description information.

In another embodiment, the attribute information of the input device may be obtained based on the feedback information of the associated device. The feedback information may be the recognition result of the associated device, and accordingly, the associated device may be an image acquisition device. The feedback information may also be the attribute description of the input device input by the user through the associated device, and accordingly, the associated device may be a device that may collect voice data, gesture image data, or string data. The present disclosure does not specifically limit this.

After the attribute information of the input device is obtained, the target display area may be determined at least based on the positional relationship by at least one of the following determination methods.

In one embodiment, the entire area of the display screen that is not covered by the input device may be determined as the target display area. The display screen may be a single screen or a dual screen. When the display screen is a single screen, the target display area may be an area that is not covered by a keyboard, a touchpad, or a stylus, etc. For example, after placing a physical keyboard on a desktop large-screen device, the entire non-covered area of the display screen of the large-screen device may be determined as the target display area. For another example, only a part of the area below or to the right of the physical keyboard may be considered as the target display area. In the case of a dual-screen display screen, only the non-covered area of the first display screen or the second display screen where the input device is placed may be determined as the target display area to display a virtual keyboard, a virtual touchpad, or a taskbar, etc., and the other screen may continue to be used to display the window interface of the currently running application of the electronic apparatus, or the system desktop.

In another embodiment, when the input device and the display screen have a first positional relationship, at least a part of the area between a first edge of the input device and a third edge of the display screen may be determined as the target display area. The first positional relationship may indicate that the placement direction of the input device is consistent with the length and width direction of the display screen, and the area between the long edge of the keyboard or touchpad and the long edge of the display screen may be used as the target display area. As an example, FIG. 2 shows a schematic diagram of the target display area determined by this determination method.

It should be noted that the display screen in FIG. 2 may be a whole foldable screen, or a first display screen and a second display screen connected to each other. When the first positional relationship indicates that the placement direction of the input device is consistent with the length and width direction of the first display screen, the area between the long edge of the keyboard or touchpad and the long edge of the first display screen may be used as the target display area, and the second display screen may also be used as the target display area. The embodiments of the present disclosure do not specifically limit this.

In another embodiment, when the input device and the display screen have a second positional relationship, at least a portion of the area between a second edge of the input device and a fourth edge of the display screen may be determined as the target display area. The second positional relationship may indicate that the long side and the wide side of the input device correspond to the wide side and the long side of the display screen respectively, that is, the long side of the keyboard or touchpad corresponds to the short side of the display screen. Therefore, at least part of the area between the short side edge (that is, the second edge) of the input device and the short side edge (that is, the fourth edge) of the display screen may be determined as the target display area. As an example, FIG. 3 shows a schematic diagram of the target display area determined by this determination method.

In another embodiment, when the input device and the display screen have a third positional relationship, the first display area of the display screen may be determined as the target display area, where the first display area and the input device have a third positional relationship or a fourth positional relationship. The third positional relationship may be a non-covering relationship. As shown in the schematic diagram of the target display area in FIG. 4, the input device and the display screen may be in a tiled or spliced relationship. The input device and the display screen may be connected through a connection pin. The display area adjacent to the input device may be used as the target display area. Of course, the display area of the entire display screen may also be used as the target display area.

The area of the display screen that is not covered by the input device and matches the attribute information may be determined as the target display area. For example, when the electronic apparatus is a dual-screen device, the first display screen where the keyboard is placed may be determined as the target display area, and a virtual keyboard, virtual touchpad, etc. matching the keyboard may be displayed. Further, the window interface of the application currently running on the electronic apparatus, or the system desktop may be displayed on the other screen.

After the attribute information of the input device is obtained and the target display area is determined based on the positional relationship, the display content and/or display parameters of the target display area may be controlled based on the attribute information, where the control method includes at least one of the following.

In one embodiment, the target display area may be controlled to display a virtual input control matching the input device based on the attribute information, and the function of the virtual input control may be the same as or different from the function of the input device. Optionally, when the input device is a keyboard, the corresponding virtual input control may be a keyboard or a virtual touchpad. When the input device is a touchpad, the corresponding virtual input control may be a virtual keyboard and/or a virtual touchpad. When the input device is a complete set of keyboards and mice, the corresponding virtual input control may be a virtual keyboard and/or a virtual touchpad in a nine-square grid, etc.

The function of the virtual input control may be the same as the function of the input device, indicating that the type of the virtual input control may be the same as that of the input device. For example, both the virtual input control and the input device may be keyboards, or both the virtual input control and the input device may be touchpads, etc. Therefore, in the scenario where the display screen is a dual screen or the electronic apparatus is externally extended, the virtual input control and the input device may control different display areas for display respectively.

In another embodiment, based on the attribute information, the target display area may be controlled to display function options that match the input device to realize the input function switching in cooperation with the input device. For example, different input devices may have different function options. For example, the function options of a writing board may include the switching of text color or text font, and the function options of the stylus may include the switching of line color or line thickness, based on which the target display area may be controlled to display the function options that match the input device based on the attribute information of the input device, such that the user may quickly select the desired function.

In another embodiment, based on the attribute information, the target display area may be controlled to switch from a current first display parameter to a second display parameter, where the second display parameter matches the appearance parameter of the input device or matches the second display area of the display screen. In practical applications, it may be possible to consider displaying a virtual touchpad that matches the physical keyboard in the target display area. To match the appearance parameter of the virtual touchpad with the physical keyboard, the virtual touchpad may be configured with a skin or display parameter that matches the appearance of the physical keyboard, such that the appearance of the virtual touchpad may be consistent with that of the physical keyboard. Or, the display parameters of the virtual touchpad or the displayed virtual keyboard may be controlled to be consistent or matched with the theme color of the application window or display content currently displayed in other display areas of the electronic apparatus. Or, to facilitate distinction from other display areas, the skin or theme color of the virtual keyboard or virtual touchpad may be configured to be different from other display areas.

Based on this, the display parameter of the target display area may be switched based on the attribute information, such as be switched from the current first display parameter to the second display parameter, where the second display parameter matches the appearance parameter of the input device or matches the second display area of the display screen, thereby improving the user's perception. Of course, the display parameter of the target display area may also be switched from the second display parameter to the first display parameter, such that the second display parameter may be greatly different from the appearance parameter of the input device or greatly different from the second display area of the display screen, and the user may clearly distinguish the target display area from the second display area.

In another embodiment, interactive controls displayed in the target display area or a display layout between the interactive controls may be controlled based on the attribute information and the positional relationship. To facilitate the user to use the interactive controls, after obtaining the attribute information and the positional relationship, the area in the target display area for displaying the interactive controls and the size corresponding to the area may be further determined. For example, when one interactive control is a virtual keyboard, the area for displaying the interactive control is located at the lower edge of the target display area, and the shape of the area for displaying the interactive controls is a rectangle with upper and lower sides longer than left and right sides, the virtual keyboard may be controlled to be displayed in the form of a full keyboard. When the area for displaying the interactive control is located at the left edge of the target display area, and the shape of the area for displaying the interactive controls is a rectangle with upper and lower sides similar to left and right sides, the virtual keyboard may be controlled to be displayed in the form of a nine-square grid, thereby improving the convenience of user operation.

Optionally, the display content of the target display area may also be controlled separately. As one example, controlling the display content of the target display area based on the attribute information may include at least one of the following.

When the attribute information indicates that the input device is a keyboard, a virtual touchpad or virtual keyboard matching the keyboard may be displayed and output in the target display area. For example, a virtual touchpad matching the keyboard may be displayed and output in the target display area, such that the virtual touchpad may be used in conjunction with the keyboard to better meet the input requirements. Or, a virtual keyboard matching the keyboard may be displayed and output in the target display area, such that different display screens may be controlled by the keyboard and the virtual keyboard for display when the electronic apparatus includes dual screens or the electronic apparatus is connected to an external extended screen.

When the attribute information indicates that the input device is a touchpad, a virtual keyboard or virtual touchpad matching the touchpad may be displayed and output in the target display area. As described in 1), a virtual keyboard or virtual touchpad matching the touchpad may be displayed and output, and the touchpad may be used in conjunction with the virtual keyboard or virtual touchpad in different scenarios, that is, a scenario where the electronic apparatus includes a single screen or a scenario where the electronic apparatus includes dual screens or a scenario where the electronic apparatus is connected to an external extended screen, etc.

When the attribute information indicates that the input device is a stylus, function options matching the stylus may be displayed and output in the target display area. The stylus has multiple functional options, such as editing documents, drawing, or acting as a spatial mouse for spatial control. In actual applications, when the input device is determined to be a stylus based on attribute information, the target display area may be controlled to display the functional options of the stylus, such that the user may conveniently select the desired stylus function.

When the attribute information indicates that the input device is a drawing board or a writing board, the tool options corresponding to the output may be displayed in the target display area. Similarly, the drawing board or the writing board each may have multiple tool options. For example, the drawing board may have the tool options such as the color palette, style, theme, etc. required for the painting scene, and the writing board may have the tool options such as the font or layout. When the input device is determined to be a drawing board or a writing board based on the attribute information, the target display area may be controlled to display the tool options corresponding to the drawing board or the writing board, such that the user may conveniently select the desired tool for painting or writing.

In another example, controlling the display content of the target display area based on the attribute information and the positional relationship, may include at least one of the following.

When the keyboard is placed in the first area of the display screen, a virtual touchpad matching the keyboard may be displayed in the second area of the display screen, where the second area is connected to the first area and is set in the first direction or the second direction of the first area. For example, the electronic apparatus may include a first display screen and a second display screen connected to each other, and the first display screen may be divided into an upper half screen and a lower half screen. The upper half screen may correspond to the first area, and the lower half screen may correspond to the second area, or the upper half screen may correspond to the second area, and the lower half screen may correspond to the first area. Based on this, when the keyboard is placed on the upper half of screen the first display screen, the lower half screen of the screen may be controlled to display a virtual touchpad matching the keyboard. At this time, the first direction may be the direction away from the second display screen. When the keyboard is placed on the lower half screen, the upper half screen may be controlled to display a virtual touchpad matching the keyboard, and, at this time, the second direction may be the direction close to the second display screen.

When the touchpad is placed in a third area of the display screen, a virtual keyboard matching the touchpad may be displayed in a fourth area of the display screen, where the fourth area is connected to the third area and is set in the first direction or the second direction of the third area. As in the above example, the electronic apparatus may include a first display screen and a second display screen connected to each other, and the first display screen is divided into an upper half screen and a lower half screen. The upper half screen may correspond to the first area and the lower half screen may correspond to the second area, or the upper half screen may correspond to the second area and the lower half screen may correspond to the first area. At this time, when the touchpad is placed on the upper half screen, the lower half screen may be controlled to display a virtual keyboard matching the touchpad, and the first direction may be the direction away from the second display screen. When the touchpad is placed on the lower half screen, the upper half of the screen may be controlled to display a virtual keyboard matching the touchpad, and, at this time, the second direction may be the direction close to the second display screen.

In the above two embodiments, the display content of the target display area may be controlled by attribute information and positional relationship. That is, the keyboard and the virtual touchpad matching the keyboard may be simultaneously displayed in the area where the first display screen is located, and the touchpad and the virtual keyboard matching the touchpad may be simultaneously displayed in the area where the first display screen is located, which effectively improves the convenience of users operating the electronic apparatus through the keyboard and the virtual touchpad.

In a scenario where the electronic apparatus includes a first display screen and a second display screen that are rotatably connected, controlling the displaying of the target display area of the display screen based on the positional relationship and the attribute information of the input device, may include at least one of the following.

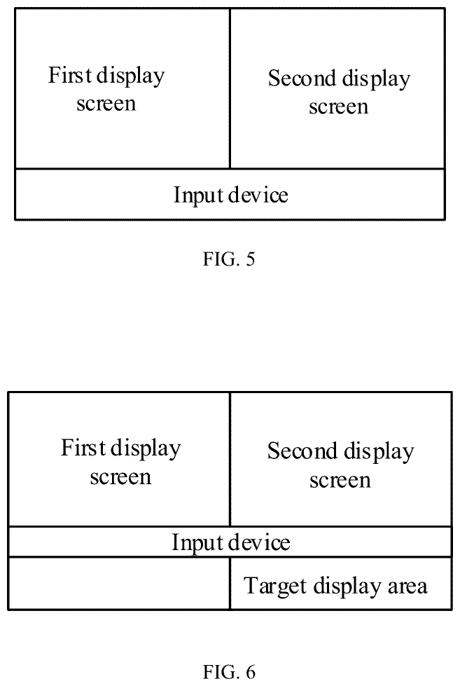

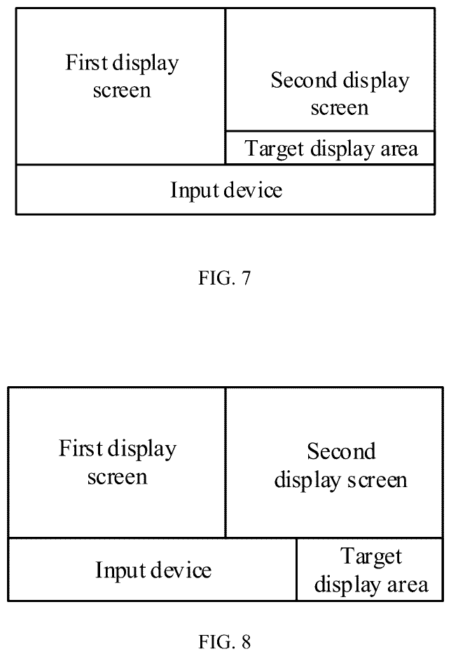

In one embodiment, when the keyboard is placed on the first display screen and the second display screen at the same time, a virtual touchpad and/or a taskbar may be displayed in the target display area. FIG. 5 shows a schematic diagram of a keyboard being placed on the first display screen and the second display screen at the same time, in which the target display area may be an area of the first display screen and the second display screen that is not covered by the keyboard, and the target display area may be set to have only a display function. FIG. 6 shows a schematic diagram of another keyboard being placed on the first display screen and the second display screen at the same time, in which the area of the first display screen and the second display screen that is not covered by the keyboard and is not the target display area may be set to have only a display function, and, at the same time, the target display area may be set to display a virtual touchpad and/or a taskbar to improve the convenience of user use. Similarly, in the schematic diagrams of the keyboard being placed on the first display screen and the second display screen at the same time, as shown in FIG. 7 and FIG. 8, a virtual touchpad and/or a taskbar may also be set to be displayed in the target display area.

In another embodiment, when the first display screen and the second display screen belong to different operating systems, a virtual input control that provides the same function as the input device may be displayed in the target display area. For example, the electronic apparatus may run two different operating systems to control different display screens through the different operating systems. Therefore, when the first display screen and the second display screen belong to different operating systems, a virtual input control that provides the same function as the input device may be set. For example, when the input device is a keyboard, the virtual input control may be set as a virtual keyboard. When the input device is a touchpad, the virtual input control may be set as a virtual touchpad, etc. And then, the input device and the virtual input control with the same function may respectively respond to the use operations under different operating systems, avoiding the confusion of the use operation caused by the user using the same input device to respond to different operations.

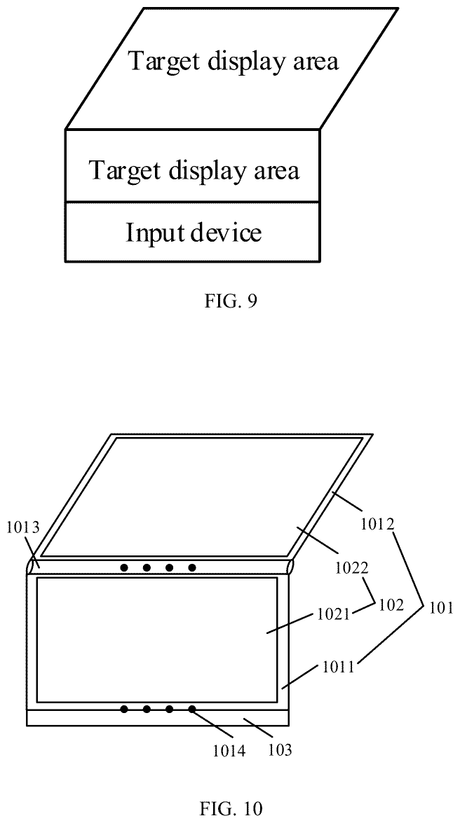

It is worth noting that for the electronic apparatus with the foldable screen, such as a foldable screen notebook, the input device may be placed on a part of the entire screen of the electronic apparatus. In this scenario, it may be also applicable to control the displaying of the target display area of the display screen based on the positional relationship and the attribute information of the input device. FIG. 9 shows a schematic diagram of a keyboard placed on a foldable screen, which will not be described in detail.

In another embodiment, when controlling the displaying of the target display area, user portrait information, current display content of the electronic apparatus, usage scenario of the electronic apparatus, power information of the electronic apparatus, or the device form of the electronic apparatus may also be obtained, and then the displaying of the target display area may be controlled based on one or more of the positional relationship, the attribute information of the input device, the user portrait information, the current display content of the electronic apparatus, the usage scenario of the electronic apparatus, the power information of the electronic apparatus, or the device form of the electronic apparatus. Therefore, controlling the displaying of the target display area of the display screen based on the positional relationship and attribute information of the input device may also include at least one of the following.

The user portrait information of the current user may be obtained, and at least one of the display content, the display parameter, or the display layout of the target display area may be controlled based on the user portrait information, the positional relationship, and the attribute information. The user portrait information may at least include user habits or preferences, such as displaying content, content theme style, display color, display transparency, or display layout, that may be more in line with user habits or preferences, in the target display area. When the display content, the display parameter, or the display layout of the target display area is controlled based on the user portrait information, the positional relationship, and the attribute information, it may be more in line with the user's habits or preferences and improve the user's experience.

The current display content of the electronic apparatus may be obtained, and at least one of the display content, the display parameter, or the display layout of the target display area may be controlled based on the current display content, the positional relationship and the attribute information. The electronic apparatus itself may determine the current display content of the electronic apparatus, such as a text editing interface, a painting interface, etc., and it may also determine the running application. Based on this, at least one of the display content, the display parameter, or the display layout of the target display area may be determined based on the displayed content and/or application, etc., combined with the positional relationship and the attribute information. For example, when the electronic apparatus detects that the currently running application is a painting-related application, the target display area may be controlled to display the corresponding tool options. When the electronic apparatus detects that the current displayed content is text editing, the target display area may be controlled to display a virtual keyboard, etc.

The usage scenario of the electronic apparatus may be obtained, and at least one of the display content, the display parameter, or the display layout of the target display area may be controlled based on the usage scenario, the positional relationship and the attribute information. In actual applications, the usage scenario of the electronic apparatus may include a game scenario, an office scenario, a meeting scenario, a video scenario, etc. For different usage scenarios, the display content, the display parameter, or the display layout of the target display area may be controlled based on the usage scenario, the positional relationship and the attribute information. For example, when the usage scenario is a game scenario, the target display area may be controlled to display an operation control similar to a game controller adapted to the game scenario to increase the user's gaming experience. When the usage scenario is a meeting scenario, the target display area may be controlled to display an interactive control such as generating a meeting summary, and after the user operates the interactive control, the meeting summary may be displayed. That is, the embodiment of the present disclosure may be applied to a variety of different application scenarios and has high versatility.

The power information of the electronic apparatus may be obtained, and at least one of the display content, the display parameter, or the display layout of the target display area may be controlled based on the power information, the positional relationship and the attribute information. The power information may at least include the power status of the electronic apparatus, such as the remaining power, and then based on the power information, that is, the power status, combined with the positional relationship and attribute information, at least one of the display content, the display parameter, or the display layout of the target display area may be controlled, such as the display brightness included in the display parameters. When the remaining power is less than the threshold, the display brightness of the target display area may be controlled to be reduced to achieve the purpose of extending the battery life of the electronic apparatus. Of course, the power information may also include whether the electronic apparatus is connected to an external power supply, etc., which will not be repeated in the embodiments of the present disclosure.

The device form of the electronic apparatus may be obtained, and at least one of the display content, the display parameter, or the display layout of the target display area may be controlled based on the device form, the positional relationship and the attribute information. Different electronic apparatuses may have different device forms, and the device forms may usually include a PC mode, a book mode, or a tent mode. For different device forms, at least one of the display content, the display parameter, or the display layout of the target display area may be controlled in combination with the positional relationship and the attribute information. For example, the display layout may be controlled. When the device form of the electronic apparatus is the book mode, the display layout may be set to any one of FIG. 5 to FIG. 8.

In the present disclosure, the displaying of the target display area of the display screen may be controlled based on the positional relationship between the display screen and the input device and the attribute information of the input device, which may ensure that the displaying of the target display area meets the user's needs, improve the user's usage efficiency and experience, and may not require manual settings by the user, with a high degree of automation.

The present disclosure also provides an electronic apparatus. As shown in FIG. 10, which is a schematic structural diagram of an electronic apparatus according to the present disclosure, in one embodiment, the electronic apparatus includes a body 101, a display screen 102, an input device 103, a detector (not shown), and a processor (not shown). The display screen 102 may be arranged at the body 101. The input device 103 may be able to move relative to the display screen 102 to have different positional relationships with the display screen 102. The detector may be used to determine the positional relationship between the display screen 102 and the input device 103. The processor may be at least used to control the displaying of the target display area of the display screen 102 based on the positional relationship and the attribute information of the input device 103. The target display area may be an area not covered by the input device 103.

In one embodiment, the body 101 may include a first body 1011, a second body 1012, and a rotation shaft 1013 that supports the rotation connection between the first body 1011 and the second body 1012. The display screen 102 may include a first display screen 1021 arranged at the first body 1011 and a second display screen 1022 arranged at the second body 1012.

In one embodiment, the input device 103 may include a detachably connected keyboard and a touchpad. When the keyboard is placed in the first area of the first display screen 1021, a virtual touchpad corresponding to the keyboard may be displayed in the second area of the first display screen 1021, where the second area is connected to the first area and is set in the first direction or the second direction of the first area.

When the touchpad is placed in the third area of the first display screen 1021, a virtual keyboard matching the touchpad may be displayed in the fourth area of the first display screen 1021, where the fourth area is connected to the third area and is set in the first direction or the second direction of the third area.

In another embodiment, a first interface 1014 may be provided on the first body 1011 and/or the rotation shaft, which is used to supply power and/or transmit data to the keyboard and/or touchpad when they are plugged in. In conjunction with the example shown in FIG. 4, the keyboard and/or touchpad are connected to the first interface 1014 on the first body 1011, that is, the keyboard and/or touchpad is provided with a second interface adapted to the first interface 1014. Through the first interface 1014 and the second interface, the keyboard and/or touchpad may be electrically connected to the first body 1011. At this time, the electronic apparatus may release electrical energy to the keyboard and/or touchpad, that is, may charge the keyboard and/or touchpad.

At this time, the keyboard and/or touchpad may be in a flat or spliced relationship with the first body 1011, that is, the keyboard and/or touchpad may be in a flat or spliced relationship with the first display screen 1021. Based on this, a part of the first display screen 1021 may be controlled to display a virtual keyboard and/or virtual touchpad, such that the user may improve the convenience of operation by combining the keyboard and/or touchpad with the virtual keyboard and/or virtual touchpad.

Since the principle of the electronic apparatus in the present disclosure is similar to the above-described display control method of the present disclosure, for the implementation of the electronic apparatus, references may be made to the implementation of the method, and similar parts will not be repeated.

Exemplary embodiments have been described herein, and their scope includes any and all embodiments based on the present disclosure with equivalent elements, modifications, omissions, combinations (e.g., schemes with various embodiments intersecting), adaptations or changes. The elements in the claims should be interpreted broadly based on the language adopted in the claims, and are not limited to the examples described in this specification or during the implementation of the present disclosure. The embodiments should be interpreted as non-exclusive. Therefore, this specification and embodiments are intended to be considered as examples only, and the true scope and spirit are indicated by the following claims and the full scope of their equivalents.

The above description is intended to be illustrative rather than restrictive. For example, the above examples (or one or more schemes thereof) may be used in combination with each other. For example, those with ordinary skills in the art may use other embodiments when reading the above description. In addition, in the above-mentioned specific embodiments, various features may be grouped together to simplify the present disclosure. This should not be interpreted as an intention that a disclosed feature that is not claimed for protection is necessary for any claim. On the contrary, the subject matter of the present disclosure may be less than all the features of a specific disclosed embodiment. Thus, the following claims are incorporated into the specific embodiments as examples or embodiments, where each claim is independently a separate embodiment, and it is considered that these embodiments may be combined with each other in various combinations or arrangements. The scope of the present disclosure should be determined by reference to the attached claims and the full scope of equivalent forms granted by these claims.

The above describes in detail multiple embodiments of the present disclosure, but the present disclosure is not limited to these specific embodiments. Those skilled in the art can make various variations and modifications based on the concept of the present disclosure, and these variations and modifications should fall within the scope of protection of the present disclosure.

What is claimed is:

1. A display control method comprising:
determining a positional relationship between a display screen of an electronic apparatus and an input device; and
controlling, at least based on the positional relationship and attribute information of the input device, displaying of a target display area of the display screen, the target display area being an area not covered by the input device.

2. The method according to claim 1, wherein determining the positional relationship includes determining the positional relationship based on at least one of:
sensing data obtained by a target sensing assembly, the target sensing assembly including a sensor arranged at at least one of the display screen, a main body where the display screen is located, or the input device;
an interface state of a connection interface arranged at the main body;
a first input operation on the display screen;
a second input operation on the electronic apparatus; or
feedback information from an associated device, a communication connection being established between the associated device and the electronic apparatus.

3. The method according to claim 1, wherein controlling displaying of the target display area includes:
determining the target display area based on the positional relationship; and
controlling at least one of a display content or a display parameter of the target display area based on the attribute information.

4. The method according to claim 3, wherein determining the target display area includes at least one of:
determining an entire area of the display screen that is not covered by the input device as the target display area;
determining, in response to the positional relationship between the input device and the display screen being a first positional relationship, at least a partial area between a first edge of the input device and a third edge of the display screen as the target display area;
determining, in response to the positional relationship between the input device and the display screen being a second positional relationship, at least a partial area between a second edge of the input device and a fourth edge of the display screen as the target display area;
determining, in response to the positional relationship between the input device and the display screen being a third positional relationship, a display area of the display screen, that has the third positional relationship or a fourth positional relationship with the input device, as the target display area; or
determining an area of the display screen that is not covered by the input device and matches the attribute information as the target display area.

5. The method according to claim 3, wherein controlling the at least one of the display content or the display parameter includes at least one of:
controlling the target display area to display a virtual input control matching the input device based on the attribute information;
controlling the target display area to display function options matching the input device based on the attribute information, the function options being configured to cooperate with the input device to realize input function switch;
controlling the target display area to switch from a current first display parameter to a second display parameter based on the attribute information, the second display parameter matching an appearance parameter of the input device or matching another display area of the display screen; or
controlling interactive controls displayed in the target display area and a display layout of the interactive controls based on the attribute information and the positional relationship.

6. The method according to claim 3, wherein controlling the display content includes at least one of:
in response to the attribute information indicating that the input device is a keyboard, displaying and outputting a virtual touchpad or a virtual keyboard matching the keyboard in the target display area;
in response to the attribute information indicating that the input device is a touchpad, displaying and outputting a virtual keyboard or a virtual touchpad matching the touchpad in the target display area;
in response to the attribute information indicating that the input device is a stylus, displaying and outputting a function option matching the stylus in the target display area; or
in response to the attribute information indicating that the input device is a drawing board or a writing board, displaying and outputting a corresponding tool option in the target display area.

7. The method according to claim 1, wherein controlling displaying of the target display area includes:
determining the target display area based on the positional relationship and the attribute information; and
controlling at least one of a display content, a display parameter, or a display layout of the target display area based on the positional relationship and the attribute information.

8. The method according to claim 7, wherein controlling the display content includes at least one of:
in response to the attribute information indicating that the input device is a keyboard and the keyboard being placed in a first area of the display screen, displaying a virtual touchpad matching the keyboard in a second area of the display screen, the second area being connected to the first area and being set in a first direction or a second direction of the first area; or
in response to the attribute information indicating that the input device is a touchpad and the touchpad being placed in a third area of the display screen, displaying a virtual keyboard matching the touchpad in a fourth area of the display screen, the fourth area being connected to the third area and being set in the first direction or the second direction of the third area.

9. The method according to claim 1, further comprising:
obtaining the attribute information of the input device by at least one of:
identifying image data of the input device obtained by an image sensor;
performing matching of sensing data obtained by a target sensing assembly in a target database;
reading, after the input device is connected to a connection interface of the electronic apparatus, the attribute information through the connection interface;
identifying description information regarding the input device input to the electronic apparatus; or
obtaining the attribute information based on feedback information of an associated device.

10. The method according to claim 1, wherein:
the display screen includes a first display screen and a second display screen; and
controlling displaying of the target display area includes at least one of:
in response to a keyboard being placed on the first display screen and the second display screen at same time, displaying at least one of a virtual touchpad or a taskbar in the target display area; or
in response to the first display screen and the second display screen belonging to different operating systems, displaying a virtual input control that provides same function as the input device in the target display area.

11. The method according to claim 1, wherein controlling displaying of the target display area includes controlling at least one of a display content, a display parameter, or a display layout of the target display area based on the positional relationship, the attribute information, and at least one of:
user portrait information of a current user,
a current display content of the electronic apparatus,
a usage scenario of the electronic apparatus,
power information of the electronic apparatus, or
a device form of the electronic apparatus.

12. An electronic apparatus comprising:
a main body;
a display screen arranged at the main body;
an input device configured to move relative to the display screen;
a detector configured to determine a positional relationship between the display screen and the input device; and
a processor configured to control displaying of a target display area of the display screen at least based on the positional relationship and attribute information of the input device, the target display area being an area not covered by the input device.

13. The electronic apparatus according to claim 12, wherein:
the main body includes a first body, a second body, and a rotation shaft supporting a rotation connection between the first body and the second body.

14. The electronic apparatus according to claim 13, wherein:
the display screen includes a first display screen arranged at the first body and a second display screen arranged at the second body;
the input device includes a detachable keyboard and a detachable touchpad; and
the processor is further configured to:
in response to the keyboard being placed in a first area of the first display screen, display a virtual touchpad corresponding to the keyboard in a second area of the first display screen, the second area being connected to the first area and being arranged in a first direction or a second direction of the first area; and
in response to the touchpad being placed in a third area of the first display screen, display a virtual keyboard matching the touchpad in a fourth area of the first display screen, the fourth area being connected to the third area and being arranged in the first direction or the second direction of the third area.

15. The electronic apparatus according to claim 13, wherein:
at least one of the first body or the rotation shaft is provided with an interface configured to supply power and/or transmit data to at least one of the keyboard or the touchpad when the at least one of the keyboard or the touchpad is plugged in.

16. The electronic apparatus according to claim 12, wherein the processor is further configured to determine the positional relationship based on at least one of:
sensing data obtained by a target sensing assembly, the target sensing assembly including a sensor arranged at at least one of the display screen, a main body where the display screen is located, or the input device;
an interface state of a connection interface arranged at the main body;
a first input operation on the display screen;
a second input operation on the electronic apparatus; or
feedback information from an associated device, a communication connection being established between the associated device and the electronic apparatus.

17. The electronic apparatus according to claim 12, wherein the processor is further configured to, when controlling displaying of the target display area:
determine the target display area based on the positional relationship; and
control at least one of a display content or a display parameter of the target display area based on the attribute information.

18. The electronic apparatus according to claim 12, wherein the processor is further configured to, when controlling displaying of the target display area:
determine the target display area based on the positional relationship and the attribute information; and
control at least one of a display content, a display parameter, or a display layout of the target display area based on the positional relationship and the attribute information.

19. The electronic apparatus according to claim 12, wherein the processor is further configured to:
obtain the attribute information of the input device by at least one of:
identifying image data of the input device obtained by an image sensor;
performing matching of sensing data obtained by a target sensing assembly in a target database;
reading, after the input device is connected to a connection interface of the electronic apparatus, the attribute information through the connection interface;
identifying description information regarding the input device input to the electronic apparatus; or
obtaining the attribute information based on feedback information of an associated device.

20. The electronic apparatus according to claim 12, wherein:
the display screen includes a first display screen and a second display screen; and
the processor is further configured to, when controlling displaying of the target display area, perform at least one of:
in response to a keyboard being placed on the first display screen and the second display screen at same time, display at least one of a virtual touchpad or a taskbar in the target display area; or
in response to the first display screen and the second display screen belonging to different operating systems, display a virtual input control that provides same function as the input device in the target display area.
